(19) United States
(12) Patent Application Publication
(10) Pub. No.: US 2014/0143607 A1
(43) Pub. Date: May 22, 2014

(54) Dedicated Network Diagnostics Module for a Process Network

(71) Applicant: Phoenix Contact Development & Manufacturing, Inc., (US)

(72) Inventors: Brian Vogt, Harrisburg, PA (US); Brenton Eugene Helfrick, Middletown, PA (US); Aaron Richard Kreider, Elizabethtown, PA (US); Davis Mathews, Lewisberry, PA (US)

(73) Assignee: Phoenix Contact Development & Manufacturing, Inc., Middletown, PA (US)

(21) Appl. No.: 13/763,208

(22) Filed: Feb. 8, 2013

Related U.S. Application Data
(60) Provisional application No. 61/597,483, filed on Feb. 10, 2012.

(51) Int. Cl. G06F 11/07

(52) U.S. Cl. CPC G06F 11/079
USPC 714/43

(57) ABSTRACT

A network diagnostic module coupleable to a distributed process control network that controls an industrial process via field devices coupled to the network includes a power block coupleable to the network and configured to power the network diagnostic module with energy received from the network, a communications block coupleable to the network and configured to bi-directionally communicate over the network, and a diagnostics block coupleable to the network and configured to make diagnostic measurements of network and protocol parameters of the network. The network diagnostic module is not itself a field device that detects or controls any process variable of the industrial process, enabling the network diagnostic module to be placed essentially anywhere along the network to permanently monitor the network.

### FIELD OF THE INVENTION

The invention relates to a control system for real-time distributed control, and more specifically, to a diagnostic device or module for the control system.

### BACKGROUND OF THE INVENTION

Automated industrial systems have field devices that monitor, control, and operate an industrial process. Each field device detects or control process variables of the industrial process.

The field devices communicate with a control processor or head through a trunk that transmits power to the field devices and transmits data signals (which can include operating commands) between the control processor and the field devices. The field devices each attach to the trunk via a spur or branch connection. The field devices can be distributed throughout the industrial plant, and the data transmittal rates allow essentially real-time control of the process.

Standardized network configurations such as Fieldbus or Profibus PA™ have been developed for distributed control systems that include standardized power and communication protocols. For example, the FOUNDATION™ Fieldbus H1 protocol is an all-digital, serial, two-way communication network that sends DC power and AC signals over a twisted two-wire trunk cable and enables the control processor to communicate with and control a number of field devices.

Diagnostic devices have been developed to monitor and diagnose problems with the physical layer of the communication network. These devices are useful during startup to verify proper installation of a new network or the new installation of a field device on the network, and in the longer term, to provide early diagnosis of field device faults and monitor the health of the interconnecting network itself.

Conventional diagnostic devices for a distributed control system such as a FOUNDATION™ Fieldbus H1 network or Profibus TA™ fall into two major categories:

(a) handheld diagnostic tools intended for temporary attachment to the network, and

(b) permanently mounted diagnostic tools mounted at the network power supply in the control cabinet.

Handheld tools generally provide a display screen to display diagnostic data and may include a USB serial port that transmits the data to a personal computer. The diagnostic data is not transmitted back to the control processor over the communications network, and the handheld tool is not designed for permanent installation on the network.

Permanently mounted diagnostic tools are usually located in the same cabinet as the network power supply and require their own power supply. Being adjacent the power supply places the tools far from the harsh operating environments where the field devices are located and where most faults and physical network problems occur, thereby limiting the effective sensitivity and effectiveness of these devices. Permanently mounted diagnostic tools may monitor a number of different networks and not monitor any one of the networks continuously, and may use a communications protocol different from the network protocol.

Eryurek et al. U.S. Pat. No. 6,859,755 discloses incorporating a network diagnostic tool within a field device located on the network. The diagnostic tool includes a power module, a network communications interface, and diagnostic circuitry. The power module draws power from the network to power the diagnostic tool as well as the field device. The diagnostic circuitry measures a number of parameters related to the network, and the diagnostic data can be transmitted to the control processor over the network by the network communications interface.

There are disadvantages in incorporating a network diagnostic tool in a field device. A field device having an incorporated network diagnostic tool is more expensive than a field device without such a tool. Furthermore, the network locations to which the network diagnostic tool can be attached are limited to only those network locations in which a field device can be attached, and so are limited to ends of spurs or branch connections. These locations may not be optimal for network diagnostics.

Providing redundant diagnostic tools on the network can be expensive because more field devices with such tools must be provided, and the redundant diagnostic tools are separated along the network that may prevent locating the multiple diagnostic tools at optimum locations on the network.

Thus there is a need for a diagnostic tool that can be installed permanently on the network away from the power supply and located independently of the field devices, with the ability to have multiple diagnostic tools to be coupled to the network at locations independent of one another and the field devices.

### BRIEF SUMMARY OF THE INVENTION

The invention is a network diagnostic module coupleable to a distributed process control network that controls an industrial process via field devices coupled to the network.

A network diagnostic module in accordance with the present invention includes a power block coupleable to the network and configured to power the network diagnostic module with energy received from the network, a communications block coupleable to the network and configured to bi-directionally communicate over the network, and a diagnostics block coupleable to the network and configured to measure and obtain electrical and protocol parameters of the network.

An important feature of the network diagnostic module is that it is not a field device—the network diagnostic module is dedicated to diagnostics and is not configured to detect or control any process variable of the industrial process.

Because the network diagnostic module is not a field device, the module can be installed on the network independently of the field devices. This enables the module to be coupled to the network almost anywhere along the network, including being spaced away from the field devices. Since the field devices are normally located at the end of spurs or branches of the network, this enables the network diagnostic module to be located at a point along the network better suited for obtaining network diagnostics or more convenient for user access.

In a preferred embodiment, the network diagnostic module in accordance with the present invention is configured for use in a FOUNDATION™ Fieldbus H1 network, and is seen as another field device or node on the network by the control processor. The diagnostic module obtains its power from the communications network like a conventional networked-powered field device, communicates to the control processor over the network utilizing the Foundation Fieldbus H1 protocol, and can be polled by the control processor.

The network diagnostic module of the present invention can be configured to communicate with the control processor only if a fault is detected on the network, or if a request for data is made of the network diagnostic module by the control processor.

Multiple network diagnostic modules of the present invention can be installed as nodes on the network for backup purposes in the event an active network diagnostic module should fail or malfunction.

In possible embodiments, the network diagnostic module of the present invention can be coupled to a device coupler that enables spurs or branching of the network.

In further possible embodiments, the network diagnostic module of the present invention can be provided with two terminals for connection to the two twisted wires of the communication network. In alternative embodiments, the network diagnostic module of the present invention can be designed to interface with a communications bus, such as the PHOENIX CONTACT T-BUS™, that mediates communication with the Fieldbus network, and can be configured as “snap on” module for mounting on a DIN rail.

Other objects and features of the invention will become apparent as the description proceeds, especially when taken in conjunction with the accompanying drawing sheets illustrating one or more illustrative embodiments of the invention.

### BRIEF SUMMARY OF THE DRAWINGS

FIG. 1 is a block diagram of a network diagnostic module in accordance with the present invention;

FIG. 2 illustrates a pair of the network diagnostic modules shown in FIG. 1 forming part of a modular control system; and

FIG. 3 illustrates a network diagnostic module in accordance with the present invention attached to a spur extending from a device coupler.

### DETAILED DESCRIPTION OF THE INVENTION

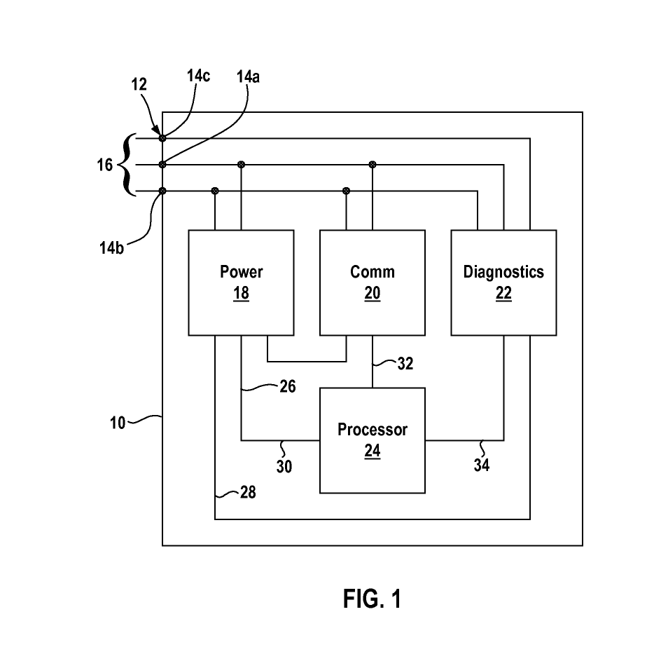

FIG. 1 illustrates a dedicated network diagnostic module in accordance with the present invention. The illustrated diagnostic module 10 is configured for use with a FOUNDATION™ Fieldbus H1 network and includes a trunk interface 12 for coupling the module 10 to the network. The illustrated trunk interface 12 includes two terminals 14a, 14b for connection to the F+ and F− wires of the two-wire trunk cable of the fieldbus network and a third terminal 14c for attaching to a shield wire if present. The diagnostic module 10 is shown with the terminals 14a, 14b, 14c connected to the signal, ground, and shield wires of a network trunk 16.

The diagnostic tool 10 includes a power block 18, a communications block 20, a diagnostic block 22, and a controller or processor 24.

The power block 18 draws electrical energy for the diagnostic module 10 from the network trunk 16 and provides power to the other blocks 20, 22, 24 and any additional internal components of the diagnostics module as indicated by electrical connections 26, 28, 30 interconnecting the power block 18 with the other blocks. The power block 18 does not provide power to any field device or other device on the network.

The communications block 20 is configured to understand the FOUNDATION™ Fieldbus H1 network protocol and can read data transmitted along the network trunk 16 and can transmit data along the network trunk 16. The communications block 20 is configured to enable the diagnostic module 10 to be seen as another field device or node on the network by the network's control processor.

The diagnostics block 22 includes the necessary circuitry and analog-to-digital converters for measuring and digitizing a number of electrical and protocol parameters of the network trunk 16 when the diagnostics module 10 is connected to the trunk 16. Examples of measurements include, but are not limited to:

segment DC voltage;

detection of shield shorted to F+ or F−;

LAS address;

number of active devices;

lowest device signal amplitude, including value, address, and date/time;

noise by frequency band, including average, peak, and date/time of peak in he LF, FF, and HF bands;

device add/drop, including most recent add/drop address, device add/drop, and date/time of device add/drop; and

individual device measurements (up to 24 devices for the illustrated embodiment) including device PD tag, device address, signal level, added/dropped, and retransmits.

The processor 24 is coupled to both the communications block 20 and the diagnostics block 22 by respective connections 32, 34. The processor 24 receives digitized data from the diagnostics block 22, can send or receive data from the network 14 through the communications block 20, and can respond to polling requests transmitted through the network 16 and directed to the diagnostics module 10. The processor 24 can optionally be configured to communicate with the network control processor only if a fault is detected, or if a request for data is received from the control processor.

The processor 24 may be configured to carry out some initial analysis of the diagnostic data received from the diagnostic block 22 and forward the results of such analysis to the control processor 44. The processor 24 may also be configured to generate and transmit an alarm to the control processor of the trunk network 16 if the diagnostic block 22 detects a protocol parameter exceeding a predetermined limit or being outside of a predetermined range.

The processor 24 preferably includes a microprocessor and related memory and operating software (not shown) to perform the functions of the processor 24 and to store operating parameters related to operation of the diagnostics module 10 itself.

Software and firmware updates for the diagnostic module 10 can be supplied through the network 16. If desired, the processor 24 can be connected to a USB port (not shown) or other I/O port built into the module 10 for updating software and firmware as needed.

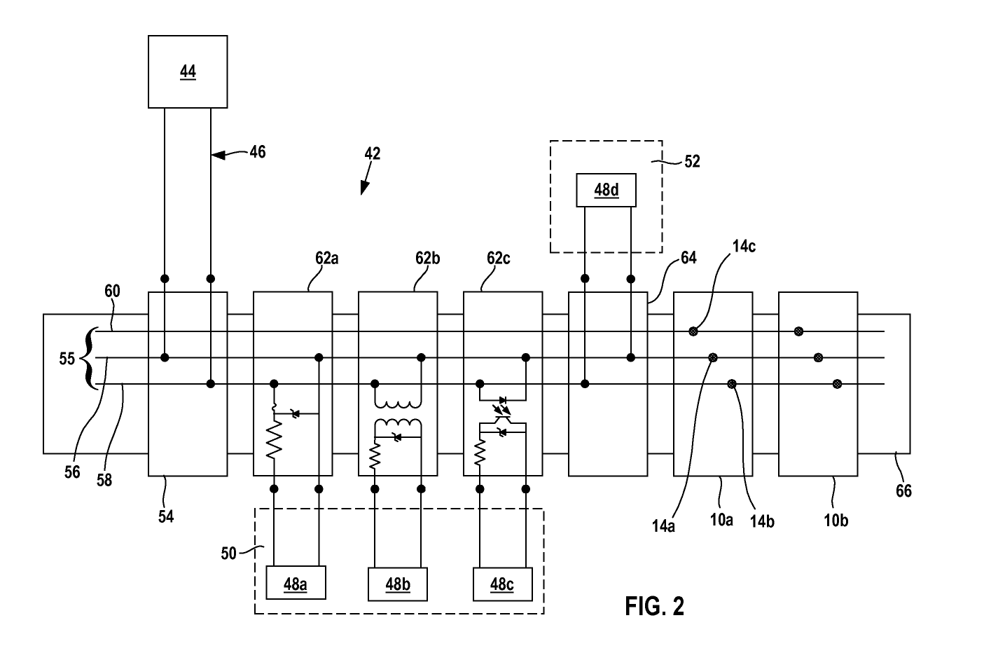

Because the diagnostic module 10 is not a field device (although the diagnostic module 10 does “cloak” itself to be seen by the control processor as a field device), that is, the diagnostic module 10 does not itself detect or control process variables, there is a great deal of versatility available in locating a diagnostic module 10 on the network. For example, FIG. 2 illustrates two like diagnostic modules 10a, 10b forming part of a FOUNDATION™ Fieldbus H1 network.

The network includes a modular control system 42 for transmitting power and data between a control processor 44 that receives and transmits signals along a trunk 46 and field devices 48a, 48b, 48c, and 48d. Each field device 48a-c is located in a hazardous area 50. Field device 48d is located in a safe area 52.

Although the trunk 46 is shown extending directly from the control processor 44 to the control system 42, there may be other device couplers (not shown) or other control systems similar to the control system 42 located downstream from the control system 42 or located along the trunk 46 between the control processor 44 and the control system 42.

The control system 42 is connected between the trunk 46 and the field devices 48 and transmits power from the trunk 42 to the field devices 48 and transmits data signals between the trunk 46 and the field devices 48. The field devices 48 may be process controllers, measurement devices, and the like as is well known in the art.

The control system 42 includes a trunk module 54 that connects the system 42 to the trunk 46. The trunk module 54 is connected to a local bus or backplane 55 having two lines, F+ and F− lines 56, 58 respectively, that conduct both DC power from the trunk module 46 and AC data signals to and from the trunk module 46 along the backplane 55, and a shield line 60. A commercially available segmented backplane that can be adapted for use as the backplane 55 is the T-BUS (trademark) modular rail bus manufactured by the applicant.

Attached to the backplane 55 are a number of field modules 62a, 62b, and 62c. The field modules 62 are removably mounted on an elongate support or rail 64 extending along the backplane that is preferably located in a control cabinet or other enclosure (not shown). Each field module 62 forms an intrinsically safe connection to a respective field device 48 located in the hazardous area 50. Also attached to the backplane and removably mounted on the rail 66 is an additional field module 66 that forms a non-intrinsically safe connection to the field device 48d located in the safe zone 52. The field modules 64 and other details of the control system 42 are disclosed in more detail in Helfrick, et al. U.S. Pat. No. 7,940,508 (the '508 patent is assigned to and presently owned by the applicant and is incorporated by reference as if fully set forth herein).

The diagnostic module 10a is mounted on the rail 66 adjacent the field module 64. The terminals 14a, 14b, 14c of the diagnostic module 10a are configured to be connected to the backplane lines 56, 58, 60 respectively when the diagnostic module 10a is mounted on rail 66.

Thee diagnostic module 10a communicates with the control processor 44 through the backplane 55 and the trunk 46, and monitors the electrical and protocol parameters related to the spur lines or field segments extending from the field modules 62, 66 and the field devices attached thereto.

The diagnostic information about the network obtained from the diagnostics block of the diagnostic module 10a is transmitted to the control processor 44, and the diagnostic module 10a can handle requests for information from the control processor 44. The diagnostic information received from the diagnostic module 10a can be used by the control processor 44 itself, or may be transferred by the control processor 44 to a separate maintenance module (not shown) off the network for more sophisticated numerical analysis of the performance, current operating state, and predicted future operating states of the network and the various field devices.

The diagnostic module 10b is mounted on the rail 66 adjacent the diagnostic module 10a and connected to the backplane lines 56, 58, 60 as described with respect to the diagnostic module 10a. The diagnostic module 10b is intended to be a redundant diagnostic module that can take over the duties of the diagnostic module 10a should the diagnostic module 10a itself fail or otherwise malfunction.

Other network diagnostic modules in accordance with the present invention can be connected to other segments of the network shown in FIG. 2. For example, a network diagnostic module could be placed in the segment joining the field module 62b and the field device 48b. If the network diagnostic module is designed to operate with voltages and currents that render the network diagnostic module intrinsically safe, the module could be placed within the hazardous area 50.

For clarity the trunk module 54, the field modules 62, 66, and the diagnostic modules 10 are drawn spaced apart in FIG. 2, but it should be understood that the modules are preferably arranged immediately side-by-side of one another to conserve space within the cabinet.

The illustrated field modules 62, 64 are “single spur” modules, that is, a field module 62, 64 connects to only a single field device. Alternatively, one or more of the field modules 62, 64 can each be a “multiple spur” device that can connect with two, three, four, or perhaps more field devices. It should be understood that the number of intrinsically safe field modules 62, non-intrinsically safe field modules 64, and diagnostic modules 38, 40 forming the control system 42 can differ from that shown in FIG. 2.

The terminals 14 of the illustrated network diagnostic module 10 are configured to attach to a T-BUS (trademark) modular rail bus. In other possible embodiments, the terminals of a network diagnostic module of the present invention can be configured for connection to wires, twisted wires, or other types of network communication buses.

The illustrated embodiment of the network diagnostic module is configured to operate with the FOUNDATION™ Fieldbus H1 protocol. Other process network protocols and network configurations are known, including without limitation other fieldbus or fieldbus-like protocols, PROFIBUS PA (trademark) protocol, ControlNet protocol, P-Net protocol, SwiftNet protocol, WorldFIP protocol, Interbus-S protocol, and FOUNDATION™ Fieldbus H2 protocol, and so other embodiments of the network diagnostic module can be configured for such other protocols or configurations.

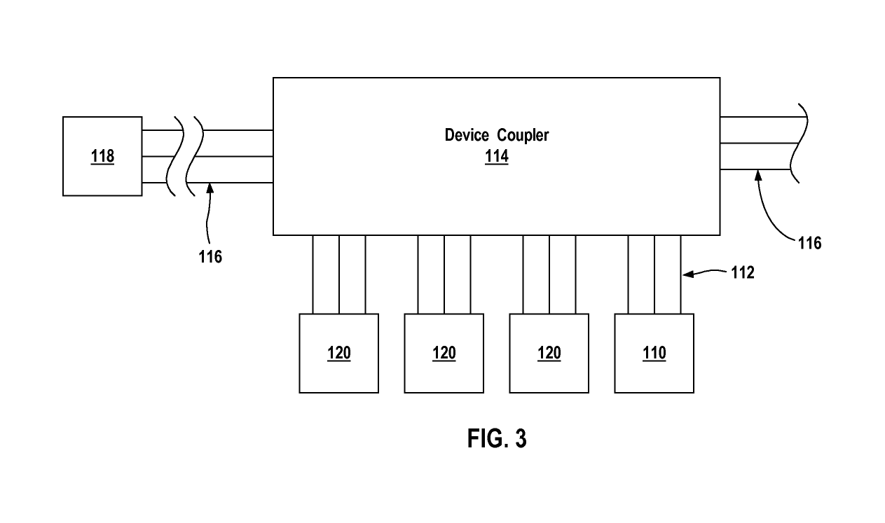

Network diagnostic modules in accordance with the present invention may also be configured to attach to or be part of a device coupler that enables spurs or branching of the network. FIG. 3 illustrates a network diagnostic module 110 in accordance with the present invention operatively connected to a spur line 112 branching from a conventional device coupler 114.

The illustrated device coupler 114 is connected in series with a trunk 116 like the trunk 46 extending from a control processor 118. One or more sets of field devices 120 are connected to respective spur lines 112b, 112c, 112d, each spur line 112 having two wires for transmitting power and data and a shield wire. The network diagnostic module 110 operates in the same manner as the network diagnostic module 10 but its terminals are configured the same as conventional field devices.

The network field device 110 is configured to be at the end of a spur, that is, to be at the downstream end of a spur. In other embodiments the field device 110 can be configured to “pass through” power and data to upstream and downstream devices. In such embodiments the network field device could be located essentially anywhere in the network—including at the power supply end of the trunk or on any spur in parallel with any field device.

While one or more embodiments of the invention have been described in detail, it is understood that this is capable of modification and that the invention is not limited to the precise details set forth but includes such changes and alterations as fall within the purview of the following claims.

1. A dedicated network diagnostic module coupleable to a distributed process control network that controls an industrial process via field devices coupled to the network, the network diagnostic module comprising:
a power block coupleable to the network and configured to power the network diagnostic module with energy received from the network;
a communications block coupleable to the network and configured to bi-directionally communicate over the network;
a diagnostics block coupleable to the network and configured to measure and obtain electrical and protocol parameters of the network;
wherein the network diagnostic module is not a field device that is configured to detect or control any process variable of the industrial process.

2. The dedicated network diagnostic module of claim 1 wherein the network diagnostic module is configured to be coupled to a network selected from the group consisting of FOUNDATION™ Fieldbus (H1), Profibus PA™, ControlNet, P-Net, SwiftNet, WorldFIP, Interbus-S, and FOUNDATION™ Fieldbus (H2).

3. The dedicated network diagnostic module of claim 1 comprising three terminals adapted to couple the network diagnostic module to the network, the three terminals comprising a pair of terminals configured to draw energy from the network and transfer communications to and from the network, and a third terminal configured to couple to a shield wire of the network.

4. The dedicated network diagnostic module of claim 3 wherein the diagnostics block is configured to be coupleable to the shield wire of the network.

5. The dedicated network diagnostic module of claim 1 comprising a processor block coupled to the diagnostics block and the communications block, the processor block configured to receive diagnostic information from the diagnostic block and transmit or receive data through the communications block.

6. The dedicated network diagnostic module of claim 5 wherein the processor block is configured to generate an alarm if the diagnostic block detects a protocol parameter of the network exceeding a predetermined limit or being outside of a predetermined range.

7. A distributed process control network comprising:
a plurality of field devices connected to one another by a network; and
a first dedicated network diagnostic module coupled to the network, the network diagnostic module comprising:
a power block coupled to the network and configured to power the network diagnostic module with energy received from the network;
a communications block coupled to the network and configured to bi-directionally communicate over the network;
a diagnostics block coupled to the network and configured to make diagnostic measurements of network and protocol parameters of the network;
the network diagnostic module not a field device and not configured to detect or control any process variable of the industrial process.

8. The distributed process control network of claim 1 wherein the first network diagnostic module is coupled to the network away from the field devices.

9. The distributed process control network of claim 8 comprising a second network diagnostic module coupled to the network.

10. The distributed process control network of claim 9 wherein the first and second network diagnostic modules are located adjacent one another along the network.

11. The distributed process control network of claim 8 wherein the second network diagnostic module is a redundant module and is active only if the first network module malfunctions.

12. The distributed process control network of claim 9 wherein the first and second modules are mounted on a common rail.

13. The distributed process control network of claim 7 wherein the network comprises a trunk and one or more network segments operatively extending from the trunk, the plurality of field devices attached to the one or more network segments, the first network diagnostic module coupled to the trunk.

14. The distributed process control network of claim 13 wherein the network comprises a backplane operatively connected to the trunk, the one or more network segments connected to and extending from the backplane to the plurality of field devices, the first network diagnostic controller coupled to the backplane.

15. The distributed process control network of claim 14 wherein the one or more network segments connected to the backplane draw energy from the backplane, the network further comprising an intrinsically safe connection between the backplane and at least one of the one or more network segments connected to the backplane.

16. The distributed process control network of claim 7 wherein the network is selected from a group consisting of a FOUNDATION™ Fieldbus (H1) network, a Profibus PA™ network, a ControlNet network, a P-Net network, a SwiftNet network, a WorldFIP network, an Interbus-S network, and a FOUNDATION™ Fieldbus (H2) network.

17. The distributed process control network of claim 7 wherein the network comprises first and second lines that transmit power and data and a third line that is a shield line, the network diagnostic module coupled to the first, second, and third lines.
